(19) United States
(12) Patent Application Publication
(10) Pub. No.: US 2024/0202576 A1
(43) Pub. Date: Jun. 20, 2024

(54) METHODS AND SYSTEMS FOR FACILITATING FEATURE ENGINEERING FOR MACHINE LEARNING MODELS

(71) Applicants: Ahmad Said Ghazal, Redondo Beach, CA (US); Hanumath Rao Maduri, Fremont, CA (US); Olli Pekka Kostamaa, Santa Monica, CA (US)

(72) Inventors: Ahmad Said Ghazal, Redondo Beach, CA (US); Hanumath Rao Maduri, Fremont, CA (US); Olli Pekka Kostamaa, Santa Monica, CA (US)

(21) Appl. No.: 18/080,929

(22) Filed: Dec. 14, 2022

(51) Int. Cl. G06N 20/00; G06F 16/953

(52) U.S. Cl. CPC G06N 20/00; G06F 16/953

(57) ABSTRACT

A system for facilitating feature engineering for machine learning models. Further, the system comprises a communication device, a processing device, and a storage device. Further, the communication device receives a request from a client device. Further, the communication device transmits a result to the client device. Further, the processing device analyzes the request. Further, the processing device determines an operation for facilitating feature engineering for a machine learning model based on the analyzing. Further, the processing device identifies a data source associated with the machine learning model based on the determining. Further, the processing device analyzes the raw data source. Further, the processing device performs an operation using an engine based on the determining, the analyzing of the request, and the analyzing of the raw data source. Further, the processing device generates the result based on the performing. Further, the storage device stores the result in a database.

### TECHNICAL FIELD

Generally, the present disclosure relates to the field of data processing. More specifically, the present disclosure relates to methods and systems for facilitating feature engineering for machine learning models.

### BACKGROUND

Machine Learning (ML) occupies a big share of the Information Technology (IT) market and may be growing rapidly. Further, ML may have some key applications such as self-driving, fraud detection, and Medical aid (disease prediction).

Feature engineering (FE) is the most difficult part of ML. Further, the existing technologies for Feature engineering are ad hoc solutions or custom applications. Further, these ad hoc solutions or custom applications for feature engineering are expensive because they required building an application/pipeline or a query to compute and store the feature. Further, these ad hoc solutions or custom applications are also not scalable because the custom solutions are not feasible for 1000's or 10000's features on many ML applications. Further, these ad hoc solutions or custom applications are redundant as they could end with duplicate/similar features. Further, these ad hoc solutions or custom applications are inaccurate as they can have errors in the application that does not meet the feature specification.

Further, state-of-the-art current Proprietary systems for feature engineering may include Meta F3™ and Uber Michelangelo Palette™. Further, Meta F3™ is based on Python and has a compiler. Further, Meta F3™ supports streaming and batch processing. Further, the Uber Michelangelo Palette™ uses a key value for feature serving, computes by Spark™, and provides a search facility. Further, state-of-the-art current open sources for facilitating feature engineering include Feathr™, Feast™, and Zipline™. Further, Feathr™ is based on Python and has a UI for defining, materializing and consuming features. Further, Feast™ is similar to Feathr™ but has lots of limitations, some of which are addressed by Tecton™. Further, Zipline™ is based on Python with SQL and allows compilation through a config file (configuration file). Further, state-of-the-art current commercial systems for feature engineering include Tecton™, AWS Stagemaker™, Splice Machine™, and Databricks™ Further, Tecton™ is Python based and has no compiler. Further, AWS Stagemaker™ is Python based and has no compiler. Further, AWS Stagemaker™ is fully managed and it ingests data. Further, Splice Machine™ is an extension to the Database Management system (DBMS) to support FE. Further, Splice Machine™ uses Python with SQL for feature definition and feature consumption through some User-defined functions (UDF). Further, Databricks™ is proprietary to databricks and uses PySpark and python to define, update and consume features.

Further, the current state of the art faces many issues. Further, the current state of the art approaches feature engineering and feature storing as an Artificial Intelligence/Machine learning (AI/ML) Infrastructure, which is like reinventing the wheel of DBMS for creating, maintaining, and consuming pre-processed data. Further, the current state of the art uses specialized systems for FE. Further, some of the specialized systems for FE ingest data. Further, the specialized systems for FE are proprietary storage for features. Further, the specialized systems for FE are hard to extend to different Compute engines. Further, the specialized systems for FE have Python representations for relational operators like joins and aggregations. Further, the specialized systems for FE have no standards and are ad-hoc. Further, the specialized systems for FE have no proper abstraction. Further, the current state of the art needs adding ML capability to an existing online analytical processing (OLAP) system as batch and streaming data are already ingested and used for BI, CRM, and other analytics. Further, the current state of the art needs adding abstraction to define features to a relational model because relational models mature with the comprehensive ecosystem. Further, the addition of the abstraction to define the feature to the relational model allow for treating the features as database objects like views and tables. Further, the addition of the abstraction to define the feature to the relational model does not reinvent the wheel for Ingesting, Data security and privacy, and Computing and retrieving data.

Therefore, there is a need for improved methods and systems for facilitating feature engineering for machine learning models that may overcome one or more of the above-mentioned problems and/or limitations.

### BRIEF SUMMARY

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating feature engineering for machine learning models, in accordance with some embodiments. Accordingly, the method may include a step of receiving, using a communication device, one or more requests from one or more client devices. Further, the one or more requests may be framed in one or more declarative languages associated with one or more database applications. Further, the method may include a step of analyzing, using a processing device, the one or more requests. Further, the method may include a step of determining, using the processing device, one or more operations for facilitating feature engineering for one or more machine learning models based on the analyzing. Further, the method may include a step of identifying, using the processing device, one or more raw data sources associated with the one or more machine learning models based on the determining. Further, the one or more data sources may include one or more raw data. Further, the method may include a step of analyzing, using the processing device, one or more raw data sources. Further, the method may include a step of performing, using the processing device, one or more operations using one or more engines based on the determining, the analyzing of the one or more requests, and the analyzing of the one or more raw data sources. Further, the one or more engines support the one or more declarative languages associated with the database. Further, the method may include a step of generating, using the processing device, one or more results based on the performing. Further, the method may include a step of transmitting, using the communication device, the one or more results to the one or more client devices. Further, the method may include a step of storing, using a storage device, the one or more results in one or more databases. Further, the performing of the one or more operations may include a step of creating one or more feature store databases for one or more compute engines associated with one or more features present in the one or more raw data using the one or more engines based on the analyzing of the one or more requests. Further, the one or more feature store databases have one or more parameters. Further, the performing of the one or more operations may include a step of adding the one or more feature store databases with the one or more parameters to one or more metadata tables using the one or more engines.

Further disclosed herein is a system for facilitating feature engineering for machine learning models, in accordance with some embodiments. Accordingly, the system may include a communication device configured for receiving one or more requests from one or more client devices. Further, the one or more requests may be framed in one or more declarative languages associated with one or more database applications. Further, the communication device may be configured for transmitting one or more results to the one or more client devices. Further, the system may include a processing device communicatively coupled with the communication device. Further, the processing device may be configured for analyzing the one or more requests. Further, the processing device may be configured for determining one or more operations for facilitating feature engineering for one or more machine learning models based on the analyzing. Further, the processing device may be configured for identifying one or more raw data sources associated with the one or more machine learning models based on the determining. Further, the one or more data sources may include one or more raw data. Further, the processing device may be configured for analyzing one or more raw data sources. Further, the processing device may be configured for performing one or more operations using one or more engines based on the determining, the analyzing of the one or more requests, and the analyzing of the one or more raw data sources. Further, the one or more engines support the one or more declarative languages associated with the database. Further, the processing device may be configured for generating one or more results based on the performing. Further, the system may include a storage device communicatively coupled with the processing device. Further, the storage device may be configured for storing the one or more results in one or more databases. Further, the performing of the one or more operations by the processing device may include creating one or more feature store databases for one or more compute engines associated with one or more features present in the one or more raw data using the one or more engines based on the analyzing of the one or more requests. Further, the one or more feature store databases may have one or more parameters. Further, the performing of the one or more operations by the processing device may include adding the one or more feature store databases with the one or more parameters to one or more metadata tables using the one or more engines.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3A is a flowchart of a method for facilitating feature engineering for machine learning models, in accordance with some embodiments.

FIG. 3B is a continuation flow chart of the method for facilitating feature engineering for machine learning models, in accordance with some embodiments.

FIG. 4 is a flowchart of a method for facilitating feature engineering for machine learning models, in accordance with some embodiments.

FIG. 5 is a flowchart of a method for facilitating feature engineering for machine learning models, in accordance with some embodiments.

FIG. 6 is a flowchart of a method for facilitating feature engineering for machine learning models, in accordance with some embodiments.

FIG. 7A is a flowchart of a method for facilitating feature engineering for machine learning models, in accordance with some embodiments.

FIG. 7B is a continuation flow chart of the method for facilitating feature engineering for machine learning models, in accordance with some embodiments.

FIG. 8 is a block diagram of a system for facilitating feature engineering for machine learning models, in accordance with some embodiments.

FIG. 9 is a block diagram of the system for facilitating feature engineering for machine learning models, in accordance with some embodiments.

FIG. 10 is a block diagram of an online SQL-ML platform, in accordance with some embodiments.

FIG. 11 is a block diagram of an online SQL-ML platform for creating a Featurestore database, in accordance with some embodiments.

FIG. 12 is a block diagram of an online SQL-ML platform, in accordance with some embodiments.

FIG. 13 is a block diagram of an online SQL-ML platform for facilitating materializing of a feature, in accordance with some embodiments.

FIG. 14 is a flow diagram of a method performed by a SQL-ML optimizer for facilitating optimization of a feature, in accordance with some embodiments.

FIG. 15 is a block diagram of an online SQL-ML platform, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and is made merely for the purposes of providing a full and enabling disclosure. The detailed disclosure herein of one or more embodiments is not intended, nor is to be construed, to limit the scope of patent protection afforded in any claim of a patent issued here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such a term to mean based on the contextual use of such a term herein. To the extent that the meaning of a term used herein—as understood by the ordinary artisan based on the contextual use of the such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but do not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list”.

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of methods and systems for facilitating feature engineering for machine learning models, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes methods and systems for facilitating feature engineering for machine learning models.

Further, the present disclosure describes feature engineering (FE). Further, feature engineering may be a process for preparing features or data attributes as input for machine learning models using domain knowledge. Further, the features may improve the quality of the input for the machine learning process in comparison to an input having raw data only. Further, feature engineering may perform data filtering, joining, and aggregation on the behalf of machine learning models. Further, feature engineering uses backends such as SQL engines, key-value stores, streaming engines, etc. Further, the feature engineering data may be batch or streaming depending upon the ML consumer needs.

Further, the present disclosure describes an example of the feature engineering of an ML prediction model for customer food delivery which predicts ETA (estimated time of arrival). Further, the required features for the model may include the size of orders, how busy the restaurant is, how quickly the restaurant can serve, and traffic conditions in the delivery area.

Further, the required features may be determined based on processing raw data. Further, the size of orders may be an aggregation over the order data, which includes restaurant ID, order ID, size, etc. Further, the required features may be streaming and batch. Further, the size of orders, how busy the restaurant is, and the current traffic condition are streaming features. Further, ‘how fast the restaurant is’ is a batch feature.

Further, the present disclosure describes an example of the feature engineering of an ML prediction model for an expected time of dine-in. Further, the ML prediction model needs the size of orders, how busy a restaurant is, and how fast the restaurant is. Further, the feature may be machine learning model features.

Further, the present disclosure describes the requirements for feature engineering, which may include Metadata, consumption, validation, and computation. Further, the metadata allows for creating/defining/replacing features, dropping features, showing features, searching for features, etc. Further, the computation may allow for materializing features, refreshing features (Automated based on metadata), etc. Further, the fetch operation retrieves the result of computed features. Further, the validation may allow for validating features based on materialization results (Delta between partitions (time stamp partitions)), validating feature dependencies in compute engines, checking primary keys of features' results, etc.

Further, the present disclosure describes the platform that may avoid the pitfalls of common solutions of feature engineering for ML. Further, the platform may support high-level user specifications for creating and manipulating features. Further, the platform may take care of translating feature specifications and generating commands to process features. Further, the platform may avoid the human cost and it may be scalable. Further, the platform may have a search capability, which helps the user to avoid redundancy. Further, the platform converts high-level domain-specific language to data processing in an automated manner to provide more accuracy. Further, the platform automates the refreshing of features to provide more accuracy.

Further, the present disclosure describes a Structured Query Language (SQL) based platform. Further, the SQL-based platform may bring feature engineering to Database Management System (DBMS) as it is more natural since feature engineering is similar to a DBMS problem, and bringing feature engineering to DBMS does not reinvent the wheel. Further, the SQL-based platform may include a SQL extension (SQL-ML) for SQL users wanting to do FE. Further, the SQL-based platform may have graph extensions and MR extensions for a similar purpose. Further, the SQL-based platform may bring feature engineering closer to SQL DBMS engines. Further, the SQL-based platform may leverage SQL engines to compute, metadata, and storage. Further, leveraging SQL engines provide a thin metadata layer in the FE platform. Further, DBMS may perceive the feature as a view to enforcing dependencies, syntax checks, etc. based on the leveraging of the SQL engines.

Further, the present disclosure describes SQL extension. Further, the SQL extension may require a feature platform compiler. Further, the SQL extension may separate FE and DBMS by allowing adding new compute engines seamlessly. Further, the SQL extension may allow leveraging of DBMS for computing and storing feature values thereby eliminating a need for feature serving like other systems. Further, one can just query the feature through SQL using the SQL extension. Further, the SQL extension may allow FE optimizations. Further, the SQL extension may allow a search for features and deduplication based on SQL-ML canonical form (feature definition), and the search allowed by the SQL extension may not only be on keywords (data source or functions) like other systems.

Further, the present disclosure describes Structured Query Language-Machine Learning (SQL-ML) system tables (metadata). Further, the SQL-ML system tables may include a feature store system table “feature_stores”. Further, the feature store system table “feature_stores” includes columns such as feature store name “feature_store_name”, compute engine database name “database_name”, compute engine parameters “engine_parameters” (such as JSON for compute engine type, login credentials, etc.), timestamp for creation date and time “creation_timestamp”, owner userid (system/OS userid) “owner”, etc.

Further, the SQL-ML system tables (metadata) may include feature system table “features”. Further, the feature system table “features” may include columns such as feature name “feature_name”, feature store name “feature_store_name”, table name on compute engine “table_name”, owner user id (system/OS userid) “owner”, list of partitions “partition_list” (each partition may be a pair having a partition value and a physical location value depending on compute engine, a partition value, file location, etc.), creation timestamp “creation_timestamp”: timestamp this feature is created (used for computing partition values), is materialization on/off “active_materialization” (for batch result), etc.

Further, the present disclosure describes a SQL extensions-feature store DDL. Further, the SQL extensions-feature store DDL allows creating FEATURESTORE [IF NOT EXISTS] feature_store_name. Further, the creation of the FEATURESTORE includes execution including issuing a create database “if not exists” for the underlying compute engine with parameters specified and adding feature_store_name to SQL-ML feature sore metadata table with parameters specified. Further, the creation of the FEATURESTORE includes errors that include ‘“feature_store_name” Database exists in the compute engine’ and ‘“feature_store_name” exists in SQL-ML metadata’.

Further, the present disclosure describes the creation of a feature store using an example. Further, the feature may be total trips by daily drivers (for example Uber drivers). Further, there may be raw data (table driver_stats) with schema including a unique ID (DRIVER_ID), a starting time for a ride (EVENT_TIMESTAMP), an ending time for the ride (COMPLETED_ON_TIME), a timestamp when the record is created (CREATION_TIMESTAMP), and an assumption of compute engines such as but not limited to, spark SQL. Further, the sample DDL on SQL-ML may CREATE FEATURESTORE IF NOT EXISTS ride_share.

Further, the execution of “CREATE FEATURESTORE IF NOT EXISTS ride_share;” includes submitting “CREATE DATABASE ride_share;” to Spark engine and Inserting into feature_store metadata table which includes feature_store_name=“ride_share”, database_name=“ride_share”, engine_parameters={“engine”:“Spark SQL”, “server”:“12.13.14.15”,“credentials”:{“login”:sql_ml_admin”:password=“****” }}, creation_timestamp=“10/14/2022:09:23:55.66”, and owner=“sql_ml_admin”. Further, all the above steps are needed for a single transaction and rolled back for any errors.

Further, the SQL extensions-feature store DDL facilitates dropping FEATURESTORE [IF EXISTS] feature_store_name [CASCADE|RESTRICT]; which includes execution comprising issuing a drop database “if exists” for underlying compute engine and removing feature_store_name from SQL-ML feature sore metadata table, and errors which include ‘“feature_store_name” Database does not exists in compute engine’, “‘feature_store_name” does not exists in SQL-ML metadata’, and restrict option used and feature store is nonempty.

Further, the SQL extensions-feature store DDL facilitates setting FEATURESTORE=feature_store_name which includes setting FEATURESTORE to feature_store_name and Default=root.

Further, the SQL extensions-feature store DDL facilitates creating [STREAM] FEATURE [IF NOT EXISTS] [feature_store_name.]feature_name <create_view_clause> AS <sql-query> PRIMARY KEY <col-name> PARTITION BY<date-time-sql-expression>; (<create_view_clause> is a list of column names, <sql-query> is a SELECT statement based on the SQL definition (initially Calcite) a feature can also be used in FROM clause of <sql-query>), and PRIMARY KEY <col-name> that specifies which column in feature is the primary key (Also, uniqueness is not enforced but the VALIDATE statement can be used subsequently to do the checking), <date-time-SQL-expression> (which is applicable to batch only since it is used for scheduling the materialization, not applicable to streaming since streaming features need to run continuously), objective is to specify the frequency of materialization of feature value like this: <col>[BY<time-unit>], (<col> should be either a date or timestamp field and should be included in feature schema and it should be based on some timestamp of raw source data, and assuming that the feature engineering is based on chronological events and raw data should have some date or timestamp value to capture when the date is captured or event occurred), and timestamp column, which is included in the output of feature implicitly. Further, values of the timestamp column are bucketed by the granularity specified and one can uniquely compute partition value from the timestamp column. Assuming the creation of timestamp is (10/16/2022:10:11:11.11), granularity by DAY means 10/16/2022:00:00:00.00 and granularity by HOUR means 10/16/2022:10:00:00.00.

Further, the SQL extensions-feature store DDL describes an optional “BY<time-unit>” that may specify the granularity of updating the feature value. It may be month, week, and day for the date columns. It may be a month, week, day, hour, minute, or second for the timestamp. Further, a default may be a day. An example for <date-time-SQL-expression> is PARTITION BY ORDER_DATE BY DAY in which ORDER_DATE is a date column for when the order is made. Further, in PARTITION BY ORDER_DATE BY DAY updates or materialization of features may be done daily. Further, <date-time-SQL-expression> shows partitioning which may be a logical concept and may be done physically as well for optimizations. For example, if a HIVE table may be used for the above example, partitioning it using ORDER_DATE allows the pruning of unnecessary partitions for SQL queries that may have a date filter.

Further, the SQL extensions-feature store DDL may allow execution which includes issuing a create view to the host databases (DB), which includes creating view database_name.feature_name <create_view_clause> AS<sql-query> to compute engine for databaase_name (corresponding database in compute engine to feature_store_name in SQL-ML)(This may help in maintaining feature dependency on underlying tables, create a table feature_name_table with the same schema as the above) (Physical partitioning of the table can be done if the underlying engine supports that. For example, Hive table partitioning is done that mimics the partitioning clause), and insert metadata in SQL-ML in “features” system table.

Further, the SQL extensions-feature store DDL may include semantic errors if the feature exists (no if not exists option used), underlying compute engine view or table exists, errors in the partition by incorrect granularity and the column used is not date or time stamp.

Further, the present disclosure describes an example of creating a feature based on SparkSQL host DB that includes: CREATING FEATURE RIDE_SHARE.TRIP_ROLLUP AS select DRIVER_ID, count (*) as TOTAL_TRIPS from DRIVER_STATS group by DRIVER_ID PRIMARY KEY DRIVER_ID PARTITION BY CREATION_TIMESTAMP BY DAY.

Further, the present disclosure describes creating a feature that includes: Issue a create view using compute engines such as but not limited to, Spark SQL (create view ride_share.trip_rollup_view(driver_id,total_trips) AS Select driver_id, count(*) as total_trips from driver_stats group by driver_id), issue a create table to Spark SQL (using HIVE format as an example) create table ride_share.trip_rollup(driver_id INT,total_trips INT, partition INT) PARTITION BY partition_column; partition_column is creation_time on day boundary (Zero hours, minutes, and seconds)

Further, creating the feature includes inserting metadata in SQL-ML in the feature store table, which includes feature_name=“trip_rollup”, feature_store_name=“ride_share”, feature_type=“BATCH”, duplicate_feature=NULL, compute_engine_table=“ride_share.trip_rollup”, owner=“sql_ml_admin”, partition_list={ }, creation_timestamp=“10/14/2022:19:01:05.23”, active_materilization=FALSE.

Further, the present disclosure describes Create feature (stream) example. Further, creating the stream feature includes CREATING STREAM FEATURE IF NOT EXISTS RIDE_SHARE.TRIP_ROLLUP AS select STREAM (CREATION_TIMESTAMP to HOUR) RIDE_TIME, DRIVER_ID, count (*) as TOTAL_TRIPS from DRIVER_STATS group by RIDE_TIME, DRIVER_ID PRIMARY KEY DRIVER_ID. Further, ‘Stream’ keyword may identify the feature as a streaming feature. Further, it may be optional as a source may be a hint and assume calcite syntax as an example. Further, feeding <SQL> may also have stream semantics. Further, PARTITION BY may be NA and errors out. Further, when SQL may not be the stream SQL, the STREAM may not be provided. Further, HOST DB provides support that may be required for the STREAM feature if not there is an error otherwise. Further, the present disclosure describes inserting metadata in SQL-ML in the feature store table. Further, the metadata includes feature_name=“trip_rollup”, feature_store_name=“ride_share”, feature_type=“STREAM”, duplicate_feature=NULL, compute_engine_table=“ride_share.trip_rollup”, owner=“sqlml_admin”, partition_list { }, creation_timestamp=“10/14/2022:19:01:05.23”, and active_materilization=FALSE.

Further, the present disclosure describes syntax or command for the execution of the stream feature. Further, SparkSQL may be used as an example for compute engine. Further, the execution includes parsing the SQL and generating a SPARK STREAMING job.

Further, executing stream features using the SparkSQL as an example for a compute engine. Further, parsing the SQL and generating a SPARK STREAMING job includes val innputDF=(spark. readStream.format (“DRIVER_STATS”). option (“host”, host). option (“port”, port). load ( )) (this defining the data source) and inputDF.groupBy(window ($“CREATION_TIME”, “1 hour”), #“DRIVER_ID”). count(.as(“TRIP_ROLLUP”) (this may define grouping aggregation on a streaming source with an hour window). Further, the Streaming feature may only start when the materialization runs. Further, the MATERIALIZE STOP <streaming-feature> may stop the running of the streaming feature.

Further, the present disclosure describes the features that may be treated as relations and may be referenced in other feature definitions. Further, Feature A may be called a derived feature if it references at least one other feature B in its definition. Further, the SQL query for this may be as follows: [FEATURE_STORENAME]. FEATURE_NAME <CREATE_VIEW_CLAUSE> AS<SQL-query-with-features-as-source> PRIMARY KEY <col-name> PARTITION BY<date-time-SQL-expression>. Further, considering <SQL-query-with-features-as-source>, if FROM clause contains at least one feature then it may be a derived feature, a feature may be a relation in SQL-ML, therefore the DERIVED feature may have a feature as an input source (making it Input-Feature), and a select query may be arbitrarily complex with multiple features and input source tables. Further, Characteristics of INPUT-FEATURE and DEFINING-FEATURE may include an INPUT-FEATURE’ partition clause which may be more granular than the DEFINING-FEATURE. Further, INPUT-FEATURE and DEFINING-FEATURE may be related to the same PRIMARY-KEY. Further, the present disclosure describes the features that may be treated as relations and may be referenced in other feature definitions. Further, Feature A may be called a derived feature if it references at least one other feature B in its definition. Further, Feature B is called the input feature if feature A partitioning may be based on feature B partitioning and the Feature B partition clause may be more granular than the derived feature. Further, the DERIVED feature is important because it allows the combination of features into one feature, resuing of the storage, and reusing of the computation.

Further, a feature store RIDE_SHARE includes the feature definition, “CREATE FEATURE RIDE_SHARE.TRIP_ROLLUP_HOURLY AS select DRIVER_ID, count (*) as TOTAL_TRIPS_HRLY from DRIVER_STATS group by DRIVER_ID PRIMARY KEY DRIVER_ID PARTITION BY CREATION_TIME_STAMP by HOUR” (CREATION_TIME_STAMP may be added to RIDE_SHARE.TRIP_ROLLUP_HOURLY with an hour boundary (zero seconds) as described before) Further, another user/data scientist needs to create a feature of total_trips per DAY.

Further, the feature definition for that feature may be, “CREATE FEATURE RIDE_SHARE.TRIP_ROLLUP_DAILY AS select DRIVER_ID, sum(TOTAL_TRIPS_HRLY) as TOTAL_TRIPS_DAILY from TRIP_ROLLUP_HOURLY group by DRIVER_ID PRIMARY KEY DRIVER_ID PARTITION BY CREATION_TIME_STAMP by DAY” Further, RIDE_SHARE.TRIP_ROLLUP_HOURLY may be the input feature.

Further, RIDE_SHARE.TRIP_ROLLUP_DAILY may be the derived feature. Further, input feature partitioning granularity is an hour. It may be more granular than derived feature granularity which is a day.

Further, the present disclosure describes SQL extensions (Feature DDL) including materializing. Further, the materializing may be used to materialize/persist features for both batch and streaming. Further, Create features just take care of the metadata part. Further, the syntax for the materializing feature may include MATERIALIZE FEATURE [START|STOP] [FEATURE_STORE_NAME]. FEATURE_NAME [WHERE <col><op><value>] (<col> may be the timestamp column used in PARTITION BY). Further, the START may start the materialization of features. For streaming, SQL-ML may submit a streaming job/query.

Further, the START for the batch option includes updating FEATURES.ACTIVE_MATERILIZATION=TRUE. As the materialization may be driven by partitioning, there may be a need for computing and storing. Further, all partitions are materialized since the last partition is materialized if no filter is specified. For example, if the partition is 1 DAY and the last partition may be done at <date> then all partitions between <date> and the current date partition are computed. Further, if the partition filter is specified then the above logic is applied only to the range of values in the date range specified by the filter. Further, specifying the partition filter may also provide backfilling if the range in the filter includes the date/time stamp of the pre-creation time. Further, materialize runs asynchronously for batch subsequently.

Further, the materialization includes a stop option for streaming in which the SQL-ML will kill the running streaming job. Further, the materialization includes a stop option for batch, in which the asynchronous job is put on hold by setting FEATURES.ACTIVE_MATERILIZATION=false. Further, the materialization schedule checks using FEATURES.ACTIVE_MATERILIZATION.

Further, the present disclosure describes an example for materialize batch. Further, the example may include MATERIALIZE RIDE_SHARE.TRIP_ROLLUP. Further, the materializing RIDE_SHARE.TRIP_ROLLUP includes updating the features system table and setting ACTIVE_MATERILIZATION true for RIDE_SHARE.TRIP_ROLLUP feature, assuming the current timestamp to be “10/16/2022:10:00:00.00”, and the SQL-ML compiler find partitions to compute. Further, the partition granularity is a day. Further, partition 0 (10/14), and partition 1 (10/15) need to be computed. Further, the execution may include issuing insert-select query to Spark SQL, // partition 0 INSERT INTO RIDE_SHARE.TRIP_ROLLUP SELECT DRIVER_ID, count (*), 0 PARTITION=0 FROM DRIVER_STATS GROUP BY DRIVER_ID // partition 1 similar to above. Further, updating the partition list for RIDE_SHARE.TRIP_ROLLUP feature system table to {0,1}.

Further, the present disclosure describes an example for materialize stream. Further, the example includes MATERIALIZE RIDE_SHARE.TRIP_ROLLUP. Further, creating a streaming feature example for RIDE_SHARE.TRIP_ROLLUP. Further, the execution of the command kickstarts the streaming job for the underlying compute engine. Further, using SparkSQL as an example for compute engine. Further, the compute engine parses the SQL and generates a SPARK STREAMING job. Further, the streaming data source is defined by val inputDF=(spark. readStream.format(“DRIVER_STATS”). option (“host”, host). option (“port”, port). load ( )). Further, grouping and aggregation on streaming sources with an hour window are defined by inputDF.groupBy(window ($“CREATION_TIME”, “1 hour”), #“DRIVER_ID”). count( ).as(“TRIP_ROLLUP”).

Further, the present disclosure describes a SQL extension-feature DDL having a Describe feature [FEATURE_STORE_NAME] FEATURE_NAME. Further, prints associated with the Describe feature create a feature statement, view a name in the compute engine, and materialize the data. Further, the materialization of the data leads to the table and its list of partitions for one table for all partitions solution and the list of tables capturing feature materialized results (for all partitions) for a table per partition solution. Further, getting information for specific partitions requires adding a filter on the partition column. Further, the addition of the filter on the partition column includes: Describe feature [FEATURE_STORE_NAME]. FEATURE_NAME [where partition <op><value>]; <op> can be any of {=, <, <=, >, >=, < >}. Further, the SQL extension feature DDL includes Validate feature [FEATURE_STORE_NAME]. FEATURE_NAME. Further, the Validate feature validates primary key uniqueness. Further, the Validate feature validates features in the metadata of SQL-ML and the underlying compute engine. Further, the Validate feature validates feature data partition demographics which may change from the previous day or the same day a week ago.

Further, the present disclosure describes a consuming feature of the SQL extensions. Further, the consuming feature may allow users to directly query the tables(s) stored in compute engine hosting the feature data. Further, for the consuming feature, accessing control is the same as “views” and one may leverage the same logic of DBMS. Further, in the consuming feature, the user may use the Describe feature to get the table(s) information and may also use the information explicitly or through a tool of DBMS. Further, users may query SQL-ML for feature values. Further, the user may use the query for partition elimination, global optimizations, and ML serving/training based on SQL.

Further, the present disclosure describes a SQL-ML feature search of the SQL extension. Further, the SQL-ML feature search may be allowing searching an existing catalog of features by a keyword, a data source, a feature definition (feature DDL in SQL-ML), etc. Further, ML engineers may create a new feature and may check for another feature in the system that covers their new feature and similar features they may use as templates or examples.

Further, the present disclosure may describe the SQL-ML feature search. Further, the SQL-ML feature search may be associated with CLI/GUI that takes keywords (table, column, filter)->list of features with same keywords <search-term>: <search-term>{AND|OR}<search-term><search-term>: <operator>=<string-value><operator>: {SOURCE|FILTER|PARTITION}. Further, the search results may be sorted based on an exact match for SOURCE, an exact match for PARTITION, a partial match for SOURCE, a partial match for PARTITION, and any match for FILTER. Further, the commands for feature search may include SOURCE=“DRIVER_STATS” OR PARTITION=“CREATION_TIMESTAMP BY DAY” SOURCE=“DRIVER_STATS” AND FILTER=“DRIVER_ID IS NOT NULL”. Further, the present disclosure describes a SQL-ML architecture. Further, the SQL-ML architecture may include an optimizer as part of the compiler. Further, the SQL-ML architecture may not intend to optimize the SQL part of SQL-ML (feature definition). Further, the SQL part should be covered by the underlying compute engine. Further, exceptions may be made when the underlying compute engine is missing crucial optimizations. Further, the SQL-ML optimizer focuses on cross-feature optimization. Further, Feature materialization may consume a lot of resources. Further, the features typically have some common data/processing. Further, lots of features on a few data sources. Further, the table scans may be expensive and may be made common across features. Further, computing common parts once during feature materialization.

Further, the present disclosure describes a SQL-ML optimizer of the SQL extension. Further, the SQL-ML optimizer is used for finding the most beneficial commonality (greatest common denominator) between two features. Further, the commonality between the two features may be common SQL, for this case, the problem is addressed in the literature and one can leverage the existing solutions for the problem and the optimality may be system resources (CPU, memory, and network) or latency. Further, the commonality between the two features may be a commonality in the primary key which may be not required since the SQL-ML has to do with storing results only. Further, the commonality between the two features may be a commonality in PARTITION BY, for this case, f1 partition by “p1” subset of f2 partition by “p2” (or vice versa). Further, P1 may be a proper subset of P2. Further, F1 materialization may be used to compute F2, otherwise, their materialization window is the same.

Further, the present disclosure describes the SQL-ML optimizer. Further, the SQL-ML optimizer facilitates features pairwise optimization that may be done during feature creation. Further, pairwise optimization includes defining views on the base tables with different combinations, such as CREATE FEATURE RIDE_SHARE.TRIP_ROLLUP_DAILY AS select DRIVER_ID, count (*) as TOTAL_TRIPS_DAILY from DRIVER_STATS group by DRIVER_ID PRIMARY KEY DRIVER_ID PARTITION BY CREATION_TIME_STAMP by DAY CREATE VIEW V1 as select * from DRIVER_STATS CREATE VIEW V2 as select DRIVER_ID, count (*) as TOTAL_TRIPS from DRIVER_STATS group by DRIVER_ID. Further, pairwise optimization includes rewriting the feature as a derived feature SQLs, which includes an algorithm that compares both the feature's subgraphs and checks for subgraph equality, and if they are equal the global optimizer replaces it. Further, pairwise optimization includes choosing the combination which may produce the minimum cost. Further, the optimization may be triggered during the create feature. Further, once the optimization may be done one may rewrite the host SQL to use the rewritten queries. Further, the optimization may trigger manually by metadata or a sync task.

Further, a first feature for the SQL-ML optimizer is Feature TRIP_ROLLUP_HOURLY (“CREATE FEATURE RIDE_SHARE.TRIP_ROLLUP_HOURLY AS select DRIVER_ID, count (*) as TOTAL_TRIPS_H from DRIVER_STATS group by DRIVER_ID PRIMARY KEY DRIVER_ID PARTITION BY CREATION_TIMESTAMP BY HOUR”, each output row has CREATION_TIMESTAMP bucketed by HOUR). Further, a second feature for the SQL-ML optimizer is Feature TRIP_ROLLUP_DAILY (“CREATE FEATURE RIDE_SHARE.TRIP_ROLLUP_DAILY AS select DRIVER_ID, count (*) as TOTAL_TRIPS_D from DRIVER_STATS group by DRIVER_ID PRIMARY KEY DRIVER_ID PARTITION BY CREATION_TIMESTAMP BY DAY”, each output row may have CREATION_TIMESTAMP bucketed by DAY). Further, the SQL-ML optimizer performs the feature to SQL conversion. Further, the Feature RIDE_SHARE.TRIP_ROLLUP_HOURLY may be converted to following SQL: FEATURE_SQL_RIDE_HRLY (SELECT format (CREATION_TIMESTAMP, ‘yyyy-MM-dd hh’), DRIVER_ID, count (*) as TOTAL_TRIPS_H FROM DRIVER_STATS GROUP BY format (CREATION_TIMESTAMP, ‘yyyy-MM-dd hh’), DRIVER_ID). Further, feature RIDE_SHARE.TRIP_ROLLUP_DAILY may be converted to following SQL: FEATURE_SQL_RIDE_DAILY (SELECT format (CREATION_TIMESTAMP, ‘yyyy-MM-dd’), DRIVER_ID, count (*) as TOTAL_TRIPS_H FROM DRIVER_STATS GROUP BY format (CREATION_TIMESTAMP, ‘yyyy-MM-dd’), DRIVER_ID). Further, the two SQLs (HRLY, DAILY) may be input to the Global Optimizer module.

Further, the SQL-ML optimizer includes a global optimizer. Further, FEATURE_SQL_RIDE_HRLY and FEATURE_SQL_RIDE_DAILY are input to the global optimizer. Further, the Metadata i.e. table: DRIVER_STATS and cost model: DISK are also input to the global optimizer. Further, the global optimizer may be a module that uses SQL Optimization to figure out common subexpressions. Further, an exemplary output for the optimization of FEATURE_SQL_RIDE_HRLY and FEATURE_SQL_RIDE_DAILY may be:
FEATURE_SQL_RIDE_HRLY_OPTIMIZED (SELECT * from CSE)
FEATURE_SQL_RIDE_DAILY_OPTIMIZED (SELECT format (CREATION_TIMESTAMP, ‘yyyy-MM-dd’), DRIVER_ID, sum(TOTAL_TRIPS_H) as TOTAL_TRIPS_D FROM CSE GROUP BY format (CREATION_TIMESTAMP, ‘yyyy-MM-dd’), DRIVER_ID)
CSE: (SELECT Format (CREATION_TIMESTAMP, ‘yyyy-MM-dd hh’), DRIVER_ID, count (*) as TOTAL_TRIPS_H FROM DRIVER_STATS GROUP BY format (CREATION_TIMESTAMP, ‘yyyy-MM-dd hh’), DRIVER_ID)

Further, the SQL-ML optimizer performs SQL to feature conversion. Further, the example of the feature, FEATURE_SQL_RIDE_HRLY_OPTIMIZED may be equal to CSE (common subexpression between features). Further, FEATURE_SQL_RIDE_DAILY_OPTIMIZED may be rewritten consuming the FEATURE_SQL_RIDE_HRLY_OPTIMIZED fully. Further, the feature, FEATURE_SQL_RIDE_DAILY fully depends on FEATURE_SQL_RIDE_HRLY. Further, the global optimizer converts the two features to SQL-ML feature definition:
FEATURE_SQL_RIDE_HRLY (SELECT DRIVER_ID, count (*) as TOTAL_TRIPS_H FROM DRIVER_STATS GROUP BY DRIVER_ID PRIMARY KEY DRIVER_ID PARTITION BY CREATION_TIMESTAMP by HOUR)
FEATURE_SQL_RIDE_DAILY (SELECT DRIVER_ID, sum(TOTAL_TRIPS_H) as TOTAL_TRIPS_D FROM FEATURE_SQL_RIDE_HRLY GROUP BY DRIVER_ID PRIMARY KEY DRIVER_ID PARTITION BY CREATION_TIMESTAMP by DAY).

Further, the present disclosure describes an algorithm for SQL-ML optimizer. Further, the algorithm may be for (f1, f2)<-all the feature store namespace, (f1_sql, f2_sql)<-Convert f1 and f2 to SQL using feature to SQL, ({f1, f2} _OPTIMIZED_SQL, CSE)<-Input the f1_sql and f2_sql to the global optimizer. Further, creating a view on the host database for CSE (Common Sub expression. Further, rewriting the f1_optimized_sql, f2_optimized_sql to Feature Def using SQL to feature. Further, the above logic may be applied broadly in the following scenarios. Further, during the creation of a single feature for example creating f2, and f1 may be created and found through a search. Further, during the creation of multiple features in one request, which may also be called feature groups like creating f1 and f2. Further, the optimization may be done asynchronously. Further, both f1 and f2 may be created and no optimization may be applied. Further, an asynchronous process may go through features metadata and apply optimizations.

Further, the feature TRIP_ROLLUP_HOURLY (“CREATE FEATURE RIDE_SHARE.TRIP_ROLLUP_HOURLY AS select DRIVER_ID, count (*) as TOTAL_TRIPS_H from DRIVER_STATS group by DRIVER_ID PRIMARY KEY DRIVER_ID PARTITION BY CREATION_TIMESTAMP BY HOUR”, each output row may include CREATION_TIMESTAMP bucketed by HOUR) and the feature TRIP_ROLLUP_DAILY (“CREATE FEATURE RIDE_SHARE.TRIP_ROLLUP_DAILY AS select DRIVER_ID, count (*) as TOTAL_TRIPS_D from DRIVER_STATS group by DRIVER_ID PRIMARY KEY DRIVER_ID PARTITION BY CREATION_TIMESTAMP BY DAY”, each output row may include CREATION_TIMESTAMP bucketed by DAY) only differ by partition granularity. Further, after a global optimization of these features, the feature TRIP_ROLLUP_HOURLY is the same but the feature TRIP_ROLLUP_DAILY changes to (“CREATE FEATURE IF NOT EXISTS RIDE_SHARE.TRIP_ROLLUP_DAILY AS select DRIVER_ID, sum(TOTAL_TRIPS_H) as TOTAL_TRIPS_D from TRIP_ROLLUP_HOURLY group by DRIVER_ID PRIMARY KEY DRIVER_ID PARTITION BY CREATION_TIMESTAMP BY DAY”). Further, the TRIP_ROLLUP_DAILY may be rewritten by using the TRIP_ROLLUP_HOURLY feature because the earlier is totally contained in the latter. Further, the TRIP_ROLLUP_DAILY may be a derived feature of the TRIP_ROLLUP_HOURLY.

Further, the present disclosure describes a natural and simple extension (software application) for feature engineering in the SQL DBMS platform. Further, this extension and a quick adoption and deployment. Further, there may be no need for optimizations or define new operators for scans, joins, or aggregations while using this extension. Further, there may be no need to define new constructs for consuming a feature while using this extension. Further, there may be a use of FROM clause. Further, this extension leverages access control and privileges through the DBMS therefore there may be no need to reinvent the wheel like other external and custom platforms. Further, there may be no need to pull data out of DBMS for this extension as both raw and feature data stay in the SQL engine. Further, the system may fold “SQL based data wrangling” into feature engineering minimizing the cost of stages and intermediate results (data wrangling plus feature engineering in one SQL query). Further, adding a new compute engine may be transparent and easy as minor changes to metadata and execution engine are required to handle engine-specific syntax and CLI.

Further, the present disclosure describes an advanced feature for migrating a feature to a different database. Further, the feature may be “MIGRATE FEATURE ride_share.trip_rollup to production_ride_share;”.

Further, the present disclosure describes methods and systems for facilitating feature engineering for machine learning models.

Further, the present disclosure relates generally to the field of data processing. More specifically, the present disclosure relates to methods and systems for facilitating feature engineering for machine learning models.

Further, the present disclosure describes an SQL extension for feature engineering and feature stores. Further, the SQL extension may be an extension of a software application (a computer implemented method or process) executing on a computing device. Further, the software application may be a SQL (structured query language) application, a DBMS application, etc.

Further, the present disclosure describes an SQL (structured query language) extension to cover the creation, materialization, and consumption of ML (machine learning model) features.

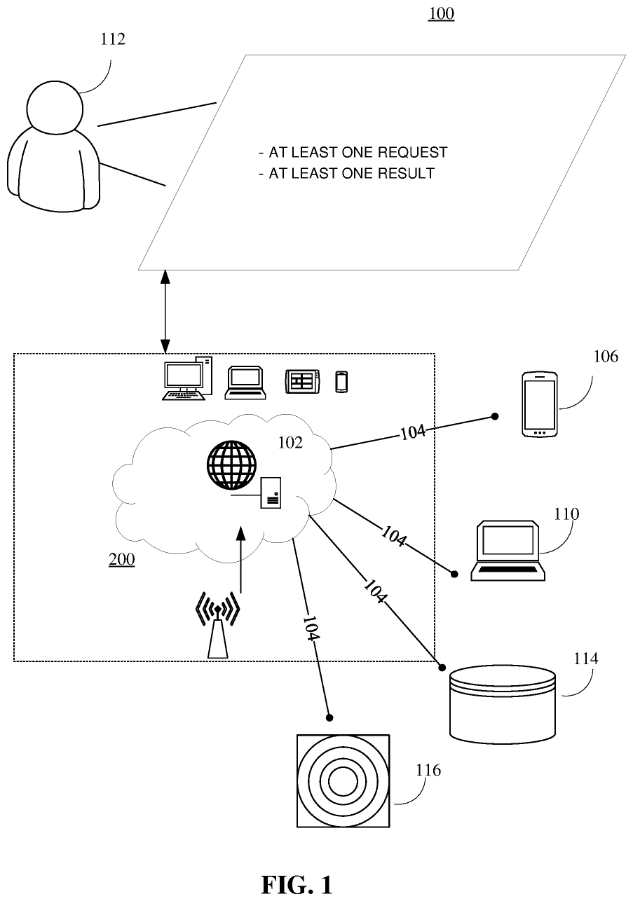

FIG. 1 is an illustration of an online platform 100 consistent with various embodiments of the present disclosure. By way of non-limiting example, the online platform 100 to facilitate feature engineering for machine learning models may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), and databases 114 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

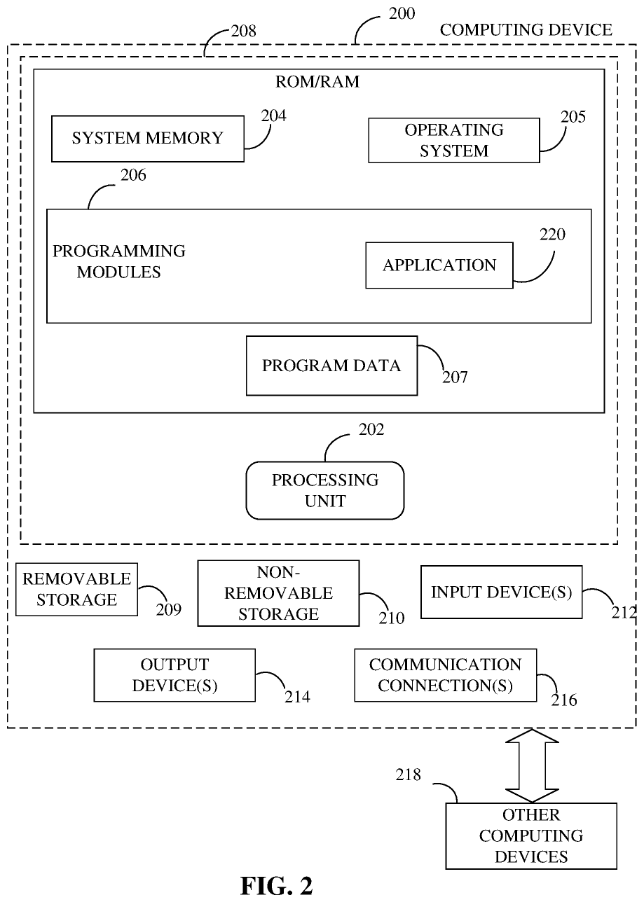

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include machine learning modules. Furthermore, embodiments of the disclosure may be practiced in conjunction with a graphics library, other operating systems, or any other application program and are not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are e2amples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, and databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

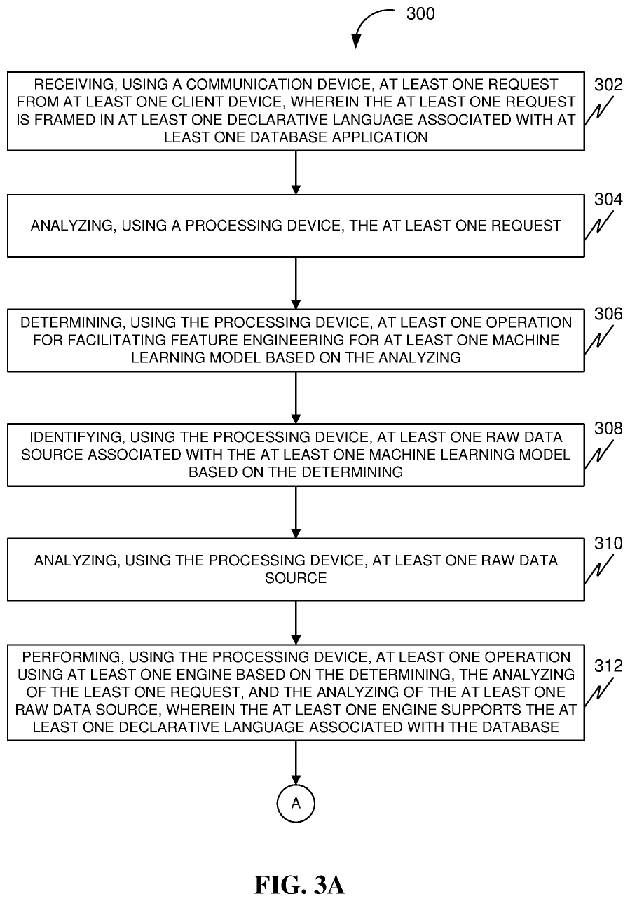

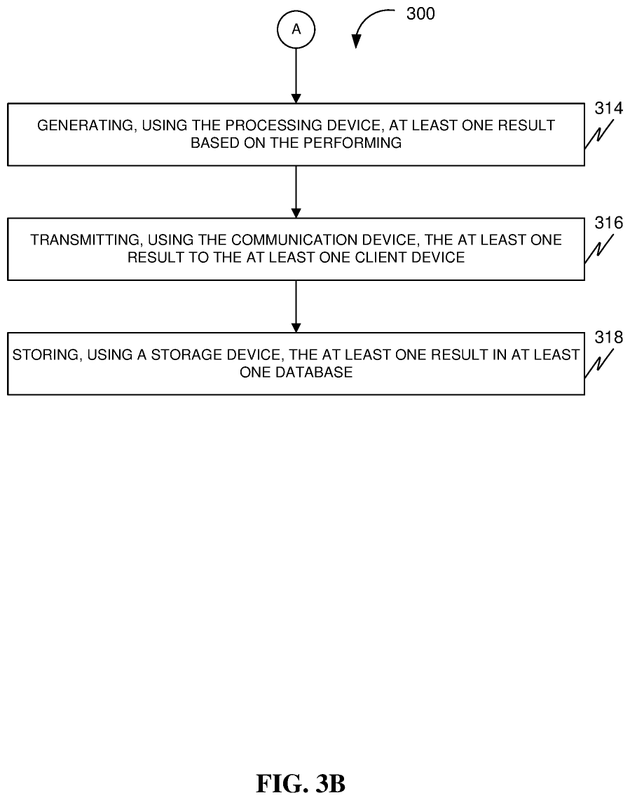

FIG. 3A is a flow chart of a method 300 for facilitating feature engineering for machine learning models, in accordance with some embodiments. Accordingly, at 302, the method 300 may include receiving, using a communication device, at least one request from at least one client device. Further, the at least one request may be framed in at least one declarative language associated with at least one database application. Further, the at least one request may include a query, a command, etc. with a syntax. Further, the at least one client device may be associated with a client. Further, the client device executes a SQL application, a (database management system) DBMS application, a (relational database management system) RDBMS application, etc. Further, the at least one request may include an instruction to perform operations. Further, the at least one database application may include the DBMS application, the RDBMS application, etc

Further, at 304, the method 300 may include analyzing, using a processing device, the at least one request. Further, the analyzing of the at least one request may include deciphering the at least one request. Further, the analyzing of the at least one request may include parsing the at least one request, optimizing the at least one request, and generating a code for the at least one request. Further, the analyzing of the at least one request may include executing the at least one request. Further, the analyzing of the at least one request may include compiling the at least one request using a compiler executed by the processing device. Further, the compiler may be a software application.

Further, at 306, the method 300 may include determining, using the processing device, at least one operation for facilitating feature engineering for at least one machine learning model based on the analyzing. Further, the at least one operation may include creating a feature store database, removing a feature store database, creating a feature, materializing a feature, creating a derived feature, feature consuming, searching a feature, optimizing a feature, defining a feature, describing a feature, etc. for features of the at least one machine learning model.

Further, at 308, the method 300 may include identifying, using the processing device, at least one raw data source associated with the at least one machine learning model based on the determining. Further, the at least one raw data source may include at least one raw data. Further, the at least one raw data source may include a database, a data store, a dataset, etc.

Further, at 310, the method 300 may include analyzing, using the processing device, the at least one raw data source.

Further, at 312, the method 300 may include performing, using the processing device, at least one operation using at least one engine based on the determining the analyzing of the at least one request and the analyzing of the at least one raw data source. Further, the at least one engine supports the at least one declarative language associated with the database. Further, the at least one engine may include a Database System Management System (DBMS) engine, a SQL (structured query language) engine, a compute engine, a query engine associated with the DBMS application, an execution engine, etc. Further, in an instance, the at least one engine may be selected based on the at least one operation. Further, the at least one engine may be a software application, a computer program, an executor, etc.

FIG. 3B is a continuation flow chart of the method 300 for facilitating feature engineering for machine learning models, in accordance with some embodiments. Accordingly, at 314, the method 300 may include generating, using the processing device, at least one result based on the performing.

Further, at 316, the method 300 may include transmitting, using the communication device, the at least one result to the at least one client device. Further, the at least one result may include a notification of a success or a failure of the performing of the at least one operation. Further, the at least one result may include a view, a table, etc.

Further, at 318, the method 300 may include storing, using a storage device, the at least one result in at least one database. Further, the at least one database may be a host database. Further, the storing of the at least one result in the at least one database may include executing at least one query associated with the storing of the at least one result using at least one engine. Further, the at least one database may include a host database.

In some embodiments, the at least one request may be framed in the at least one declarative language comprising at least one of structured query language (SQL), XML Query (XQuery), Object Query Language (OQL), SQL/XML, GraphQL, and Language Integrated Query (LINQ).

In some embodiments, the generating further includes generating at least one of a feature view and a feature table based on the creating of the at least one feature. Further, the at least one result includes at least one of the feature view and the feature table.

In some embodiments, the at least one feature includes at least one batch feature and the at least one stream feature.

In some embodiments, the performing further comprising initiating a materialization for the at least one feature using the at least one engine based on the at least one feature. Further, the generating of the at least one result may be based on the initiating of the materialization.

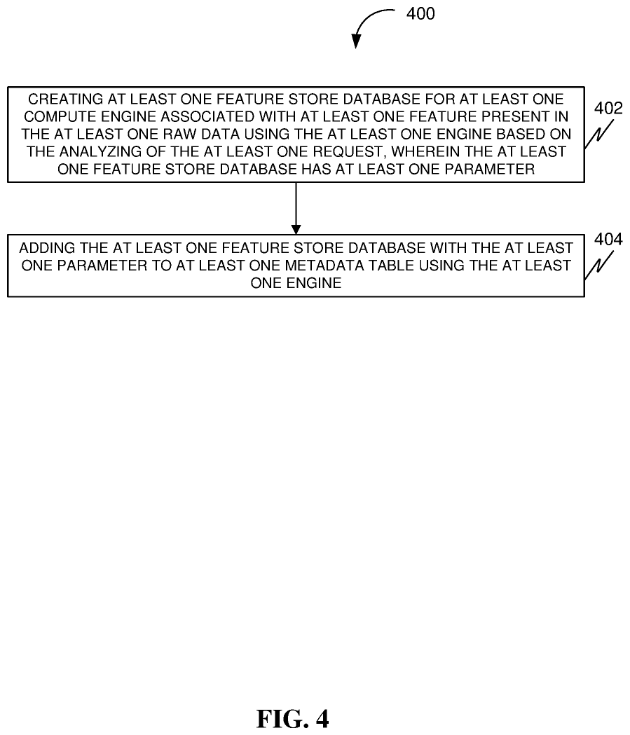

FIG. 4 is a flowchart of a method 400 for facilitating feature engineering for machine learning models, in accordance with some embodiments. Accordingly, at 402, the method 400 may include creating at least one feature store database for at least one compute engine associated with at least one feature present in the at least one raw data using the at least one engine based on the analyzing of the at least one request. Further, the at least one feature store database has at least one parameter. Further, the at least one parameter may be an engine parameter.

Further, at 404, the method 400 may include adding the at least one feature store database with the at least one parameter to at least one metadata table using the at least one engine.

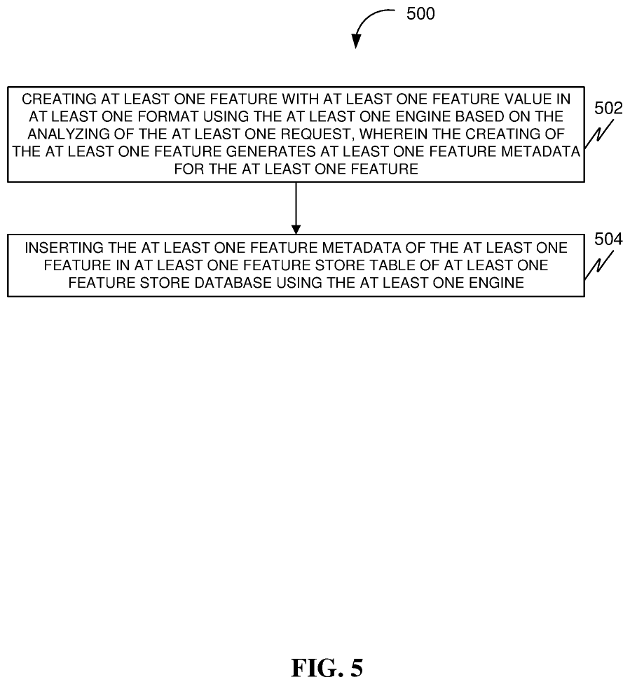

FIG. 5 is a flowchart of a method 500 for facilitating feature engineering for machine learning models, in accordance with some embodiments. Accordingly, at 502, the method 500 may include creating at least one feature with at least one feature value in at least one format using the at least one engine based on the analyzing of the at least one request. Further, the creating of the at least one feature generates at least one feature metadata for the at least one feature. Further, the at least one format corresponds to a partitioning, granularity, etc. associated with the at least one feature.

Further, at 504, the method of 500 may include inserting the at least one feature metadata of the at least one feature in at least one feature store table of at least one feature store database using the at least one engine.

In some embodiments, the method 500 further comprises removing the at least one feature store database for the at least one compute engine from the at least one metadata table using the at least one engine based on the analyzing of the at least one request.

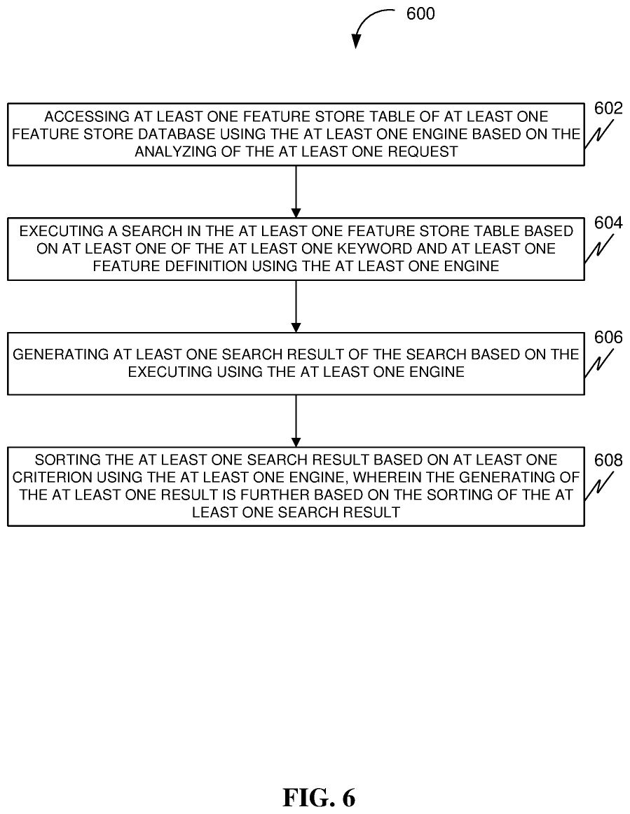

FIG. 6 is a flowchart of a method 600 for facilitating feature engineering for machine learning models, in accordance with some embodiments. Further, the at least one request may include at least one of at least one keyword and at least one feature definition associated with at least one feature. Further, the at least one keyword may include a table, a column, and a filter. Further, at 602, the method 600 may include accessing at least one feature store table of at least one feature store database using the at least one engine based on the analyzing of the at least one request.

Further, at 604, the method 600 may include executing a search in the at least one feature store table based on at least one of the at least one keyword and the at least one feature definition using the at least one engine.

Further, at 606, the method 600 may include generating at least one search result of the search based on the executing using the at least one engine. Further, the at least one search result may include entries in the at least one feature store table

Further, at 608, the method 600 may include sorting the at least one search result based on at least one criterion using the at least one engine. Further, the at least one criterion may include an exact match for a source, an exact match for a partition, a partial match for a source, a partial match for a partition, any match for a filter, etc. Further, the generating of the at least one result is further based on the sorting of the at least one search result.

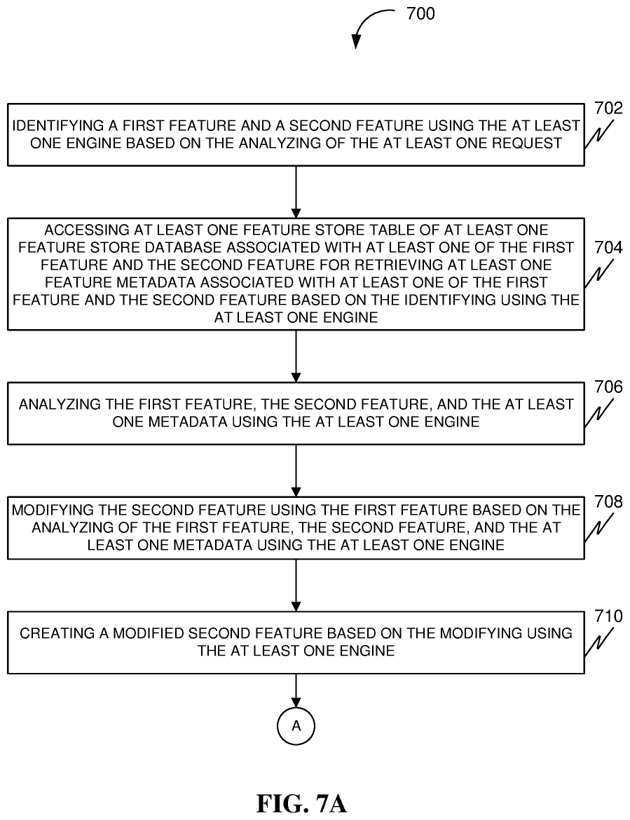

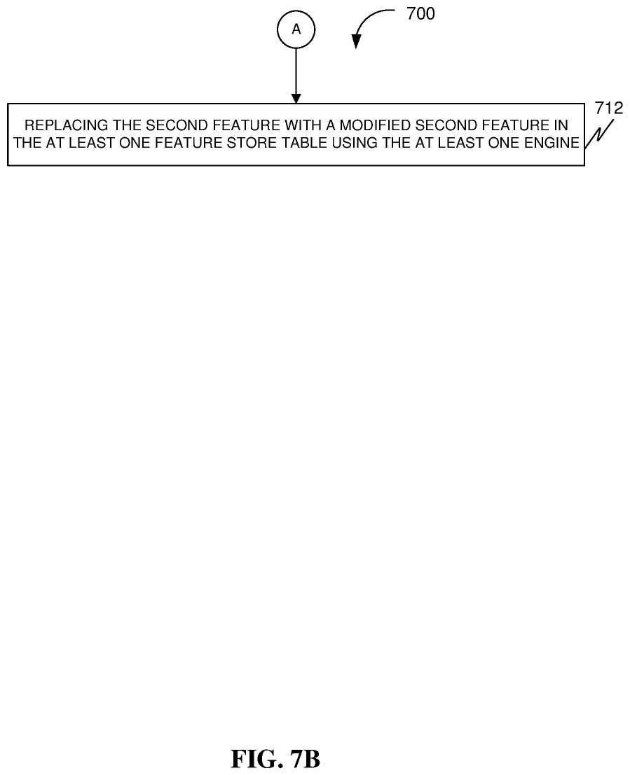

FIG. 7A is a flowchart of a method 700 for facilitating feature engineering for machine learning models, in accordance with some embodiments. Accordingly, at 702, the method 700 may include identifying a first feature and a second feature using the at least one engine based on the analyzing of the at least one request.

Further, at 704, the method 700 may include accessing at least one feature store table of at least one feature store database associated with at least one of the first feature and the second feature for retrieving at least one feature metadata associated with at least one of the first feature and the second feature based on the identifying using the at least one engine.

Further, at 706, the method 700 may include analyzing the first feature, the second feature, and the at least one metadata using the at least one engine.

Further, at 708, the method 700 may include modifying the second feature using the first feature based on the analyzing of the first feature, the second feature, and the at least one metadata using the at least one engine. Further, the modifying may include rewriting the second feature in terms of the first feature.

Further, at 710, the method 700 may include creating a modified second feature based on the modifying using the at least one engine.

FIG. 7B is a continuation flow chart of the method 700 for facilitating feature engineering for machine learning models, in accordance with some embodiments. Accordingly, at 712, the method 700 may include replacing the second feature with a modified second feature in the at least one feature store table using the at least one engine.

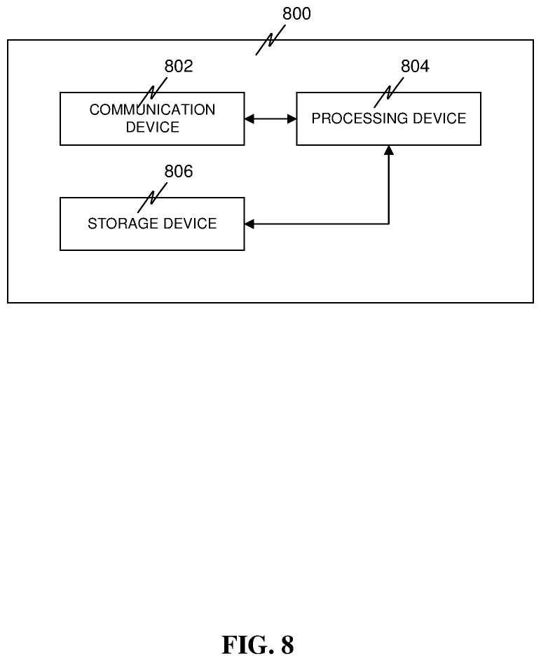

FIG. 8 is a block diagram of a system 800 for facilitating feature engineering for machine learning models, in accordance with some embodiments. Accordingly, the system 800 may include a communication device 802, a processing device 804, and a storage device 806.

Further, the communication device 802 may be configured for receiving one or more requests from one or more client devices 902. Further, the one or more requests may be framed in one or more declarative languages associated with one or more database applications. Further, the communication device 802 may be configured for transmitting one or more results to the one or more client devices 902.

Further, the processing device 804 may be communicatively coupled with the communication device 802. Further, the processing device 804 may be configured for analyzing the one or more requests. Further, the processing device 804 may be configured for determining one or more operations for facilitating feature engineering for one or more machine learning models based on the analyzing. Further, the processing device 804 may be configured for identifying one or more raw data sources associated with the one or more machine learning models based on the determining. Further, the one or more data sources may include one or more raw data. Further, the processing device 804 may be configured for analyzing one or more raw data sources. Further, the processing device 804 may be configured for performing one or more operations using one or more engines based on the determining, the analyzing of the at least one request, and the analyzing of the one or more data. Further, the one or more engines support the one or more declarative languages associated with the database. Further, the processing device 804 may be configured for generating one or more results based on the performing.

Further, the storage device 806 may be communicatively coupled with the processing device 804. Further, the storage device 806 may be configured for storing the one or more results in one or more databases.

In some embodiments, the one or more requests may be framed in one or more declarative languages comprising one or more of structured query language (SQL), XML Query (XQuery), Object Query Language (OQL), SQL/XML, GraphQL, and Language Integrated Query (LINQ).

Further, in some embodiments, the performing of the one or more operations by the processing device 804 may include creating one or more feature store databases for one or more compute engines associated with one or more features present in the one or more raw data using the one or more engines based on the analyzing of the one or more requests. Further, the one or more feature store databases may have one or more parameters. Further, the performing of the one or more operations by the processing device 804 may include adding the one or more feature store databases with the one or more parameters to one or more metadata tables using the one or more engines.

In some embodiments, the performing of the one or more operations by the processing device 804 may include removing the one or more feature store databases for the one or more compute engines from the one or more metadata tables using the one or more engines based on the analyzing of the one or more requests.

Further, in some embodiments, the performing of the one or more operations by the processing device 804 may include creating one or more features with one or more feature values in one or more formats using the one or more engines based on the analyzing of the one or more requests. Further, the creating of the one or more features generates one or more feature metadata for the one or more features. Further, the performing of the one or more operations by the processing device 804 may include inserting the one or more feature metadata of the one or more features in one or more feature store tables of one or more feature store databases using the one or more engines.

In some embodiments, the performing of the one or more operations by the processing device 804 may include generating one or more of a feature view and a feature table based on the creating of the one or more features. Further, the one or more results include one or more of the feature view and the feature table.

In some embodiments, the one or more features include one or more batch features and the one or more stream features.

In some embodiments, the performing of the one or more operations by the processing device 804 may include initiating a materialization for the one or more features using the one or more engines based on the one or more features. Further, the generating of the one or more results may be further based on the initiating of the materialization.

Further, in some embodiments, the one or more requests may include one or more of one or more keywords and one or more feature definitions associated with one or more features. Further, the performing of the one or more operations by the processing device 804 may include accessing one or more feature store tables of one or more feature store databases using the one or more engines based on the analyzing of the one or more requests. Further, the performing of the one or more operations by the processing device 804 may include executing a search in the one or more feature store tables based on one or more of the one or more keywords and the one or more feature definitions using the one or more engines. Further, the performing of the one or more operations by the processing device 804 may include generating one or more search results of the search based on the executing using the one or more engines. Further, the performing of the one or more operations by the processing device 804 may include sorting the one or more search results based on one or more criteria using the one or more engines. Further, the generating of the one or more results may be further based on the sorting of the one or more search results.

Further, in some embodiments, the performing of the one or more operations by the processing device 804 may include identifying a first feature and a second feature using the one or more engines based on the analyzing of the one or more requests. Further, the performing of the one or more operations by the processing device 804 may include accessing one or more feature store tables of one or more feature store databases associated with one or more of the first feature and the second feature for retrieving one or more feature metadata associated with one or more of the first feature and the second feature based on the identifying using the one or more engines. Further, the performing of the one or more operations by the processing device 804 may include analyzing the first feature, the second feature, and the one or more metadata using the one or more engines. Further, the performing of the one or more operations by the processing device 804 may include modifying the second feature using the first feature based on the analyzing of the first feature, the second feature, and the one or more metadata using the one or more engines. Further, the performing of the one or more operations by the processing device 804 may include creating a modified second feature based on the modifying using the one or more engines. Further, the performing of the one or more operations by the processing device 804 may include replacing the second feature with a modified second feature in the one or more feature store tables using the one or more engines.

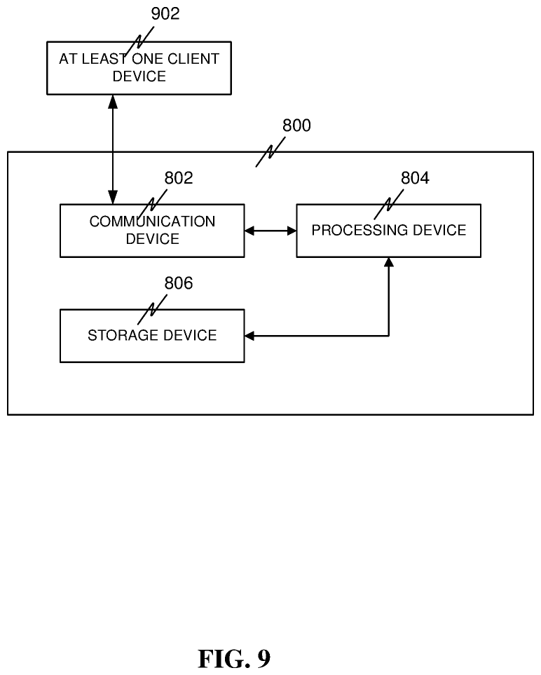

FIG. 9 is a block diagram of the system 800 for facilitating feature engineering for machine learning models, in accordance with some embodiments.

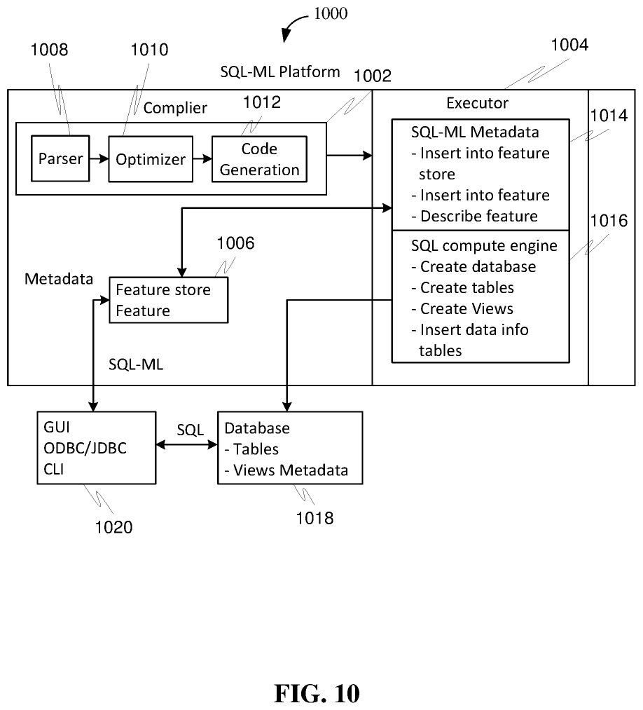

FIG. 10 is a block diagram of an online SQL-ML platform 1000, in accordance with some embodiments. Accordingly, the SQL-ML platform 1000 may include a compiler 1002, an executor 1004, and a Metadata 1006.

Further, the compiler 1002 interfaces with the executor 1004. Further, the compiler 1002 may include a parser 1008, an optimizer 1010, and a code generation 1012. Further, the parser 1008 interfaces with the optimizer 1010. Further, the optimizer 1010 interfaces with the code generation 1012.

Further, the executor 1004 interfaces with the Metadata 1006. Further, the executor 1004 may include a SQL-ML Metadata 1014 and a SQL compute engine 1016. Further, the SQL-ML Metadata 1014 inserts into a feature store, inserts into a feature, and describes a feature. Further, the SQL compute engine 1016 creates a database, creates a table, creates views, and inserts a data info table. Further, the SQL compute engine 1016 interfaces with a database 1018. Further, the database 1018 may include a table and views a Metadata. Further, the database 1018 interfaces with a device 1020.

Further, the Metadata 1006 interfaces with the SQL-ML Metadata 1014 and the device 1020. Further, the Metadata 1006 may include a feature store and a feature. Further, device 1020 may include a GUI (graphic user interface), an ODBC/JDBC, and a CLI (command line interface).

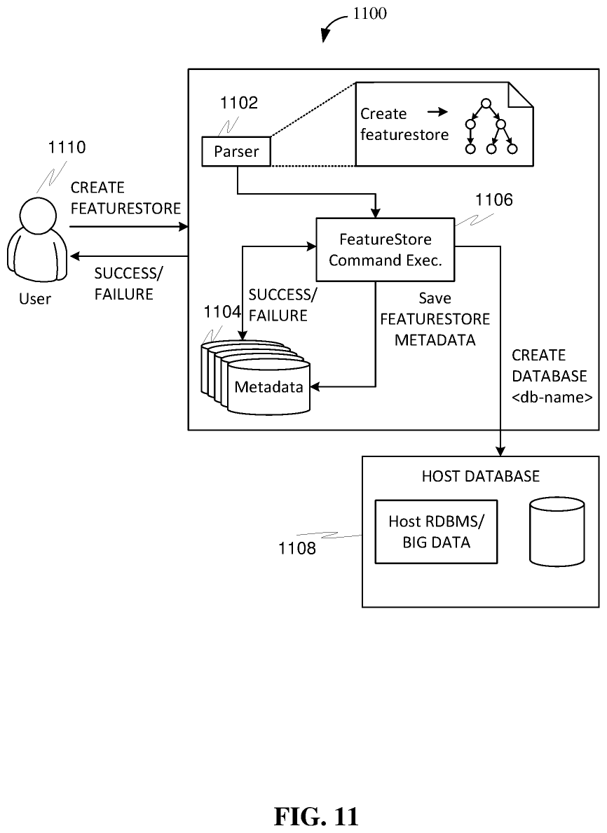

FIG. 11 is a block diagram of an online SQL-ML platform 1100 for creating a Featurestore, in accordance with some embodiments. Accordingly, the SQL-ML platform 1100 may include a parser 1102, a Metadata 1104, and a Feature store command executor 1106.

Further, the parser 1102 interfaces with the Featurestore command executor 1106. Further, the parser 1102 creates a Featurestore.

Further, the Metadata 1104 interfaces with the Featurestore command executor 1106. Further, the Metadata 1104 transmits a first success/failure notification to the Featurestore command executor 1106. Further, the Featurestore command executor 1106 saves a Featurestore Metadata in the Metadata 1104. Further, the Featurestore command executor 1106 interfaces with a host database 1108. Further, the host database 1108 hosts a RDBMS/a Big Data.

Further, a device 1110 interfaces with the SQL-ML platform 1100. Further, the device 1110 transmits a request for creating a Featurestore to the SQL-ML platform 1100. Further, the device receives a second success/failure notification from the SQL-ML platform 1100.

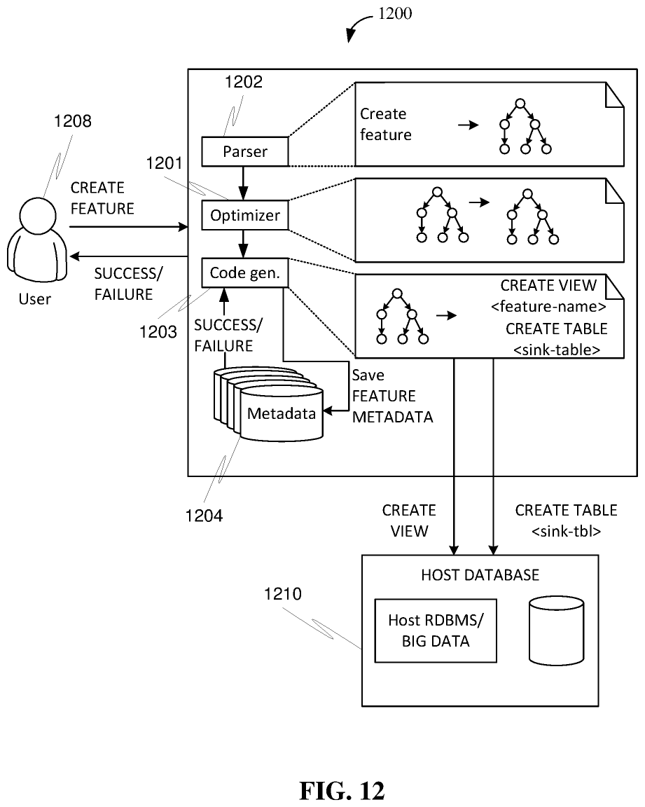

FIG. 12 is a block diagram of an online SQL-ML platform 1200, in accordance with some embodiments. Accordingly, the SQL-ML platform 1200 may include a parser 1202, an optimizer 1201, a code generation 1203, and a Metadata 1204.

Further, the parser 1202 creates a Feature. Further, the parser 1202 interfaces with the optimizer 1201. Further, the optimizer 1201 interfaces with the code generation 1203. Further, the code generation 1203 interfaces with the Metadata 1204. Further, the code generation 1203 creates a view and a table. Further, the code generation 1203 saves a Feature Metadata in the Metadata 1204.

Further, the Metadata 1204 transmits a first success/failure notification to the code generation 1203.

Further, a device 1208 of a user interfaces with the SQL-ML platform 1200. Further, the device 1208 transmits a request for creating a feature to the SQL-ML platform 1200. Further, the device 1208 receives a second success/failure notification from the SQL-ML platform 1200.

Further, a host database 1210 interfaces with the SQL-ML platform 1200. Further, the host database 1210 may include a host RDBMS/BIG DATA. Further, the view and the table are stored in the host database 1210.

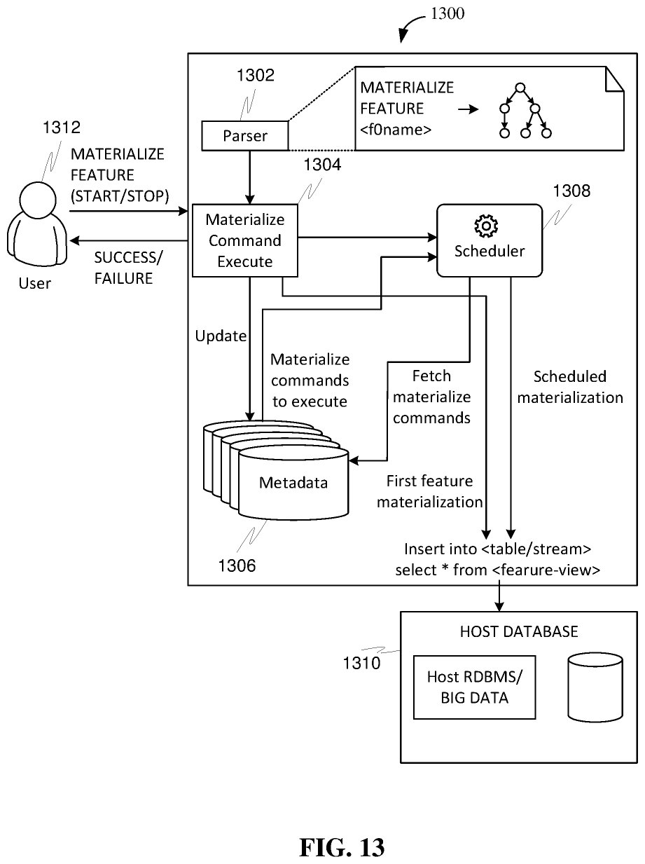

FIG. 13 is a block diagram of an online SQL-ML platform 1300 for materializing of a feature, in accordance with some embodiments. Accordingly, the SQL-ML platform 1300 may include a parser 1302, a Materialize command executor 1304, a Metadata 1306, and a scheduler 1308.

Further, the parser 1302 interfaces with the Materialize command executor 1304. Further, the parser 1302 materializes a feature.

Further, the Materialize command executor 1304 interfaces with Metadata 1306 and the scheduler 1308.

Further, the scheduler 1308 interfaces with the Metadata 1306 and a host database 1310. Further, the scheduler 1308 fetches materialized commands to the Metadata 1306. Further, the host database 1310 hosts a RDBMS/a Big data.

Further, the Metadata 1306 interfaces with the scheduler 1308. Further, the Metadata 1306 materializes commands to execute in the scheduler 1308.

Further, a device 1312 of a user interfaces with the SQL-ML platform 1300. Further, the device 1312 transmits a request for materializing a feature to the SQL-ML platform 1300. Further, the device 1312 receives a success/failure notification from the SQL-ML platform 1300.

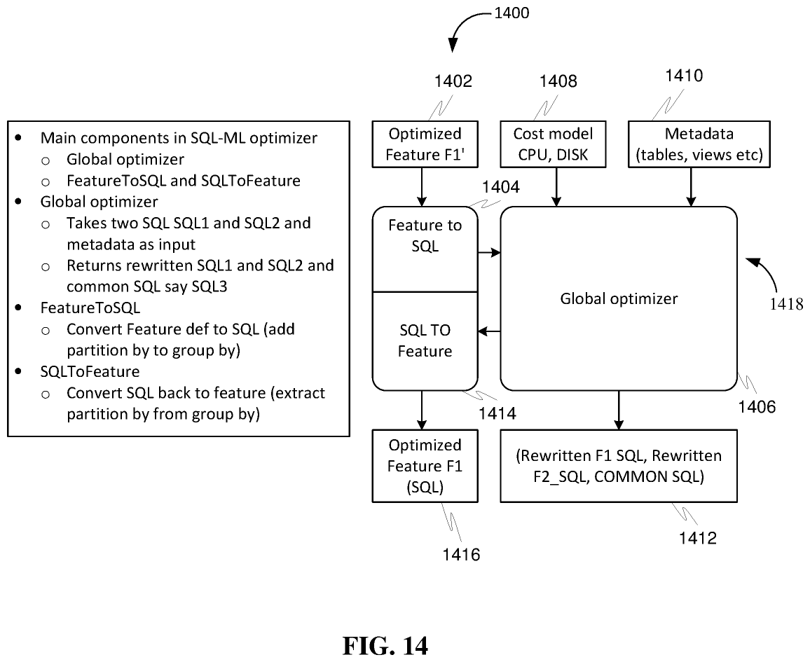

FIG. 14 is a flow diagram of a method 1400 performed by a SQL-ML optimizer 1418 for facilitating optimization of a feature, in accordance with some embodiments. Accordingly, the method 1400 may include a step of receiving an optimized feature F1 at 1402. Further, the method 1400 may include a step of converting the optimized feature F1 1402 to a feature to SQL at 1404. Further, the method 1400 may include a step of transmitting the feature to SQL at 1404 to a global optimizer 1418. Further, the method 1400 may include a step of receiving a cost model at 1408. Further, the method 1400 may include a step of receiving a Metadata at 1410. Further, the global optimizer 1418 may receive an input. Further, the global optimizer 1418 may output Rewritten F1 SQL, Rewritten F2_SQL, COMMON SQL at 1412. Further, the input may include a SQL 1, a SQL 2, and a metadata. Further, the global optimizer 1418 may transmit a rewritten SQL 1 and a rewritten SQL 2 to a SQL to feature at 1414. Further, the SQL to feature converts a SQL to feature at 1414. Further, the method 1400 may include a step of converting the SQL to feature to an optimized SQL feature F1 at 1416.

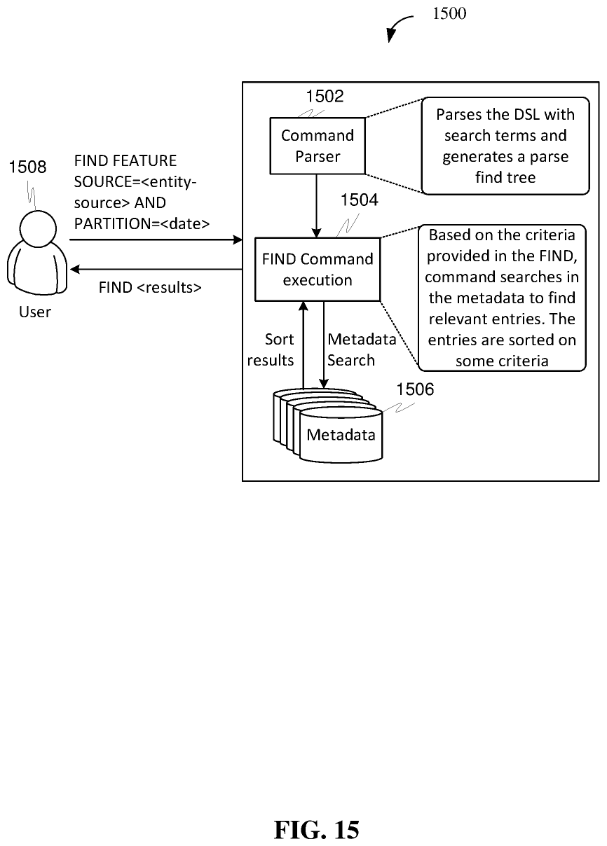

FIG. 15 is a block diagram of an online SQL-ML platform 1500, in accordance with some embodiments. Accordingly, the SQL-ML platform 1500 may include a command parser 1502, a find command executor 1504, and a Metadata 1506.

Further, the command parser 1502 interfaces with the find command executor 1504. Further, the command parser 1502 parses the DSL with search terms and generates a parse find tree.

Further, the find command executor 1504 interfaces with the Metadata 1506. Further, the find command executor 1504 may be based on criteria provided in the find. Further, the find command executor 1504 commands search in the Metadata 1506 to find entries. Further, the entries may be sorted by some criteria. Further, the find command executor transmits a Metadata search command to the Metadata 1506.

Further, the Metadata 1506 interfaces with the find command executor 1504. Further, the Metadata 1506 transmits sorted results to the find command executor 1504.

Further, a device 1508 of a user interfaces with the SQL-ML platform 1500. Further, the device 1508 transmits a request for finding a feature to the SQL-ML platform 1500. Further, the device 1508 receives a result notification from the SQL-ML platform 1500.

Although the present disclosure has been explained in relation to its preferred embodiment, it is to be understood that many other possible modifications and variations can be made without departing from the spirit and scope of the disclosure.

What is claimed is:

1. A method of facilitating feature engineering for machine learning models, wherein the method comprises:
receiving, using a communication device, at least one request from at least one client device, wherein the at least one request is framed in at least one declarative language associated with at least one database application;
analyzing, using a processing device, the at least one request;
determining, using the processing device, at least one operation for facilitating feature engineering for at least one machine learning model based on the analyzing;
identifying, using the processing device, at least one raw data source associated with the at least one machine learning model based on the determining, wherein the at least one data source comprises at least one raw data;
analyzing, using the processing device, at least one raw data source;
performing, using the processing device, at least one operation using at least one engine based on the determining, the analyzing of the at least one request, and the analyzing of the at least one raw data source, wherein the at least one engine supports the at least one declarative language associated with the database;
generating, using the processing device, at least one result based on the performing;
transmitting, using the communication device, the at least one result to the at least one client device; and
storing, using a storage device, the at least one result in at least one database.

2. The method of claim 1, wherein the at least one request is framed in the at least one declarative language comprising at least one of structured query language (SQL), XML Query (XQuery), Object Query Language (OQL), SQL/XML, GraphQL, and Language Integrated Query (LINQ).

3. The method of claim 1, wherein the performing further comprises:
creating at least one feature store database for at least one compute engine associated with at least one feature present in the at least one raw data using the at least one engine based on the analyzing of the at least one request, wherein the at least one feature store database has at least one parameter; and
adding the at least one feature store database with the at least one parameter to at least one metadata table using the at least one engine.

4. The method of claim 3, wherein the performing further comprising removing the at least one feature store database for the at least one compute engine from the at least one metadata table using the at least one engine based on the analyzing of the at least one request.

5. The method of claim 1, wherein the performing further comprises:
creating at least one feature with at least one feature value in at least one format using the at least one engine based on the analyzing of the at least one request, wherein the creating of the at least one feature generates at least one feature metadata for the at least one feature; and
inserting the at least one feature metadata of the at least one feature in at least one feature store table of at least one feature store database using the at least one engine.

6. The method of claim 5, wherein the generating further comprises generating at least one of a feature view and a feature table based on the creating of the at least one feature, wherein the at least one result comprises at least one of the feature view and the feature table.

7. The method of claim 5, wherein the at least one feature comprises at least one batch feature and the at least one stream feature.

8. The method of claim 7, wherein the performing further comprising initiating a materialization for the at least one feature using the at least one engine based on the at least one feature, wherein the generating of the at least one result is further based on the initiating of the materialization.

9. The method of claim 1, wherein the at least one request comprises at least one of at least one keyword and at least one feature definition associated with at least one feature, wherein the performing further comprises:
accessing at least one feature store table of at least one feature store database using the at least one engine based on the analyzing of the at least one request;
executing a search in the at least one feature store table based on at least one of the at least one keyword and the at least one feature definition using the at least one engine;
generating at least one search result of the search based on the executing using the at least one engine; and
sorting the at least one search result based on at least one criterion using the at least one engine, wherein the generating of the at least one result is further based on the sorting of the at least one search result.

10. The method of claim 1, wherein the performing further comprises:
identifying a first feature and a second feature using the at least one engine based on the analyzing of the at least one request;
accessing at least one feature store table of at least one feature store database associated with at least one of the first feature and the second feature for retrieving at least one feature metadata associated with at least one of the first feature and the second feature based on the identifying using the at least one engine;
analyzing the first feature, the second feature, and the at least one metadata using the at least one engine;
modifying the second feature using the first feature based on the analyzing of the first feature, the second feature, and the at least one metadata using the at least one engine;
creating a modified second feature based on the modifying using the at least one engine; and
replacing the second feature with a modified second feature in the at least one feature store table using the at least one engine.

11. A system for facilitating feature engineering for machine learning models, the system comprising:
a communication device configured for:
receiving at least one request from at least one client device, wherein the at least one request is framed in at least one declarative language associated with at least one database application; and
transmitting at least one result to the at least one client device;
a processing device communicatively coupled with the communication device, wherein the processing device is configured for:
analyzing the at least one request;
determining at least one operation for facilitating feature engineering for at least one machine learning model based on the analyzing;
identifying at least one raw data source associated with the at least one machine learning model based on the determining, wherein the at least one data source comprises at least one raw data;
analyzing at least one raw data source;
performing at least one operation using at least one engine based on the determining, the analyzing of the at least one request, and the analyzing of the at least one raw data source, wherein the at least one engine supports the at least one declarative language associated with the database; and
generating at least one result based on the performing; and
a storage device communicatively coupled with the processing device, wherein the storage device is configured for storing the at least one result in at least one database.

12. The system of claim 11, wherein the at least one request is framed in the at least one declarative language comprising at least one of structured query language (SQL), XML Query (XQuery), Object Query Language (OQL), SQL/XML, GraphQL, and Language Integrated Query (LINQ).

13. The system of claim 11, wherein the performing further comprises:
creating at least one feature store database for at least one compute engine associated with at least one feature present in the at least one raw data using the at least one engine based on the analyzing of the at least one request, wherein the at least one feature store database has at least one parameter; and
adding the at least one feature store database with the at least one parameter to at least one metadata table using the at least one engine.

14. The system of claim 13, wherein the performing further comprising removing the at least one feature store database for the at least one compute engine from the at least one metadata table using the at least one engine based on the analyzing of the at least one request.

15. The system of claim 11, wherein the performing further comprises:
creating at least one feature with at least one feature value in at least one format using the at least one engine based on the analyzing of the at least one request, wherein the creating of the at least one feature generates at least one feature metadata for the at least one feature; and
inserting the at least one feature metadata of the at least one feature in at least one feature store table of at least one feature store database using the at least one engine.

16. The system of claim 15, wherein the generating further comprises generating at least one of a feature view and a feature table based on the creating of the at least one feature, wherein the at least one result comprises at least one of the feature view and the feature table.

17. The system of claim 15, wherein the at least one feature comprises at least one batch feature and the at least one stream feature.

18. The system of claim 17, wherein the performing further comprising initiating a materialization for the at least one feature using the at least one engine based on the at least one feature, wherein the generating of the at least one result is further based on the initiating of the materialization.

19. The system of claim 11, wherein the at least one request comprises at least one of at least one keyword and at least one feature definition associated with at least one feature, wherein the performing further comprises:
accessing at least one feature store table of at least one feature store database using the at least one engine based on the analyzing of the at least one request;
executing a search in the at least one feature store table based on at least one of the at least one keyword and the at least one feature definition using the at least one engine;
generating at least one search result of the search based on the executing using the at least one engine; and
sorting the at least one search result based on at least one criterion using the at least one engine, wherein the generating of the at least one result is further based on the sorting of the at least one search result.

20. The system of claim 11, wherein the performing further comprises:
identifying a first feature and a second feature using the at least one engine based on the analyzing of the at least one request;
accessing at least one feature store table of at least one feature store database associated with at least one of the first feature and the second feature for retrieving at least one feature metadata associated with at least one of the first feature and the second feature based on the identifying using the at least one engine;
analyzing the first feature, the second feature, and the at least one metadata using the at least one engine;
modifying the second feature using the first feature based on the analyzing of the first feature, the second feature, and the at least one metadata using the at least one engine;
creating a modified second feature based on the modifying using the at least one engine; and
replacing the second feature with a modified second feature in the at least one feature store table using the at least one engine.
